(19) United States
(12) Patent Application Publication
(10) Pub. No.: US 2018/0251074 A1
(43) Pub. Date: Sep. 6, 2018

(54) IN-CAR STORAGE ORGANIZER HAVING INSERTION PLATE BODIES OF ADJUSTABLE POSITION TO MATCH THE GAP BETWEEN SEATS

(71) Applicant: AMOUNT INC., New Taipei City (TW)

(72) Inventor: Teng WANG, New Taipei City (TW)

(73) Assignee: AMOUNT INC., New Taipei City (TW)

(21) Appl. No.: 15/666,664

(22) Filed: Aug. 2, 2017

(30) Foreign Application Priority Data
Mar. 1, 2017 (TW) 106106666

(51) Int. Cl. B60R 7/04

(52) U.S. Cl. CPC B60R 7/043

(57) ABSTRACT

The present invention is an in-car storage organizer having insertion plates of adjustable position matching with gap between seats, which comprises an organizer body having a top shaped into a storage part and a bottom installed with three track grooves, and two insertion plates each having a top end formed with a track portion for enabling the insertion plate to be inserted into corresponding track groove along a front-to-rear direction of the organizer body, for firmly fixing the top end of the insertion plate to the bottom of the organizer body. Therefore, a user can select corresponding track grooves for inserting the insertion plates based on gap between two seats for enabling the width of the outer sides of the insertion plates to match with the gap, and allowing the insertion plates to be inserted into the gap seamlessly and lean against the seats for firmly supporting the organizer body.

### FIELD OF THE INVENTION

The present invention relates to an in-car storage organizer having insertion plate bodies of adjustable position to match the gap between seats, especially, a storage organizer structure having an organizer body that has a plurality of track grooves installed on the bottom thereof so that the user can select any of two track grooves for inserting two insertion plate bodies wherein the width between two outer sides of the two insertion plate bodies respectively matches the width of the gap between two seats in a car.

### BACKGROUND OF THE INVENTION

For many vehicle owners, how to organize sundry items surrounding the driver's seat during driving is a difficult task. In addition to the important items like the carry-on smartphone, wallet, keychain, there are also many other sundry items, such as the headphones, charging cables, soft drink cup, cigarettes, that need to be organized and stored. Although these items are small in size, when the quantity is high, the space in a car becomes very messy. Even though the interior of a car has many storage and organizing spaces currently (for example, storage pocket/basket, cup holder, etc.). However, some of these storage spaces are not located within arm's reach distance from the driver's seat or passenger's seat. Whenever there is a need to use these items, the driver or the passenger has to unbuckle the seat belt, lean over, and search for an item in an inconvenient manner.

Owing to the fact that the problem of “organizing car” is very common, there are a variety of organizers and storage apparatus for car owners to purchase and install inside the car by themselves. Please refer to FIG. 1. FIG. 1 is a product of “in-car storage organizer” of the prior art. The in-car storage organizer 1 comprises an organizer body 11 and an insertion plate body 12. The organizer body 11 has two cup holders 111 concavely fabricated thereon and a storage slot 112. The insertion plate body 12 is disposed on the bottom of the organizer body 11 and the structure thereof is of a plate shape. The car owner can insert the insertion plate bodies 12 into the gap between two adjacent seats of the car so that the insertion plate bodies 12 are seamlessly adjacent to the sides of the seats. Therefore, the organizer body 11 is located at either side of the seats, matching the location within arm's reach distance of the user (that is the driver or the passengers). The user can place the soft drink in the cup holder 111 fixedly or the sundry items in the storage slot 112 for storage and to be used at any time.

The aforementioned storage organizer 1 seems to solve the problems of organization and storage. However, there are still areas far from ideal in actual use of these devices. The main reasons are that the width of the gap between two seats in every car is different (likely in the scale of 2±1 cm). Thus, when the width of the insertion plate bodies 12 is smaller than that of the gap, the insertion plate bodies 12 can not closely lean against the sides of two seats, causing the storage organizer 1 to sway around and not to be firmly fixed on spot. On the contrary, when the width of the insertion plate bodies 12 is larger than that of the gap, the insertion plate bodies 12 inserted to the gap can not reach a specific depth easily. Therefore, the position of the organizer body 11 becomes comparatively high and is in contact against the arm of the user, causing interference and inconvenience to the users.

Therefore, how to improve the in-car storage organizer 1 of the prior art and make the organizer conveniently available for storage and retrieval of the sundry items and, at the same time, always maintain the steady condition of the organizer body 11 by fine adjustment in coping with different sizes of gaps between seats, becomes an important issue to be solved by the present invention.

### SUMMARY OF THE INVENTION

In view of the problems of the in-car storage organizer of the prior art, which has insertion plate bodies with a fixed gap width, preventing the organizer from fitting to different gap widths, the author of the present invention repeatedly made improvements on the design, conducted tests and adjustments based on many years of experience and eventually produced an in-car storage organizer having insertion plate bodies of adjustable position to match the gap between seats of the present invention that can effectively solve the aforementioned deficiencies.

One of the objectives of the present invention is to provide an in-car storage organizer having insertion plate bodies of adjustable position to match the gap between seats which comprises an organizer body and two insertion plate bodies. The top part of the organizer body is shaped into a storage part whereas the bottom part is installed with at least three track grooves along the direction of front-to-rear and these track grooves are in parallel to one another. The top end of each insertion plate body has a track portion wherein the structure of the track portion is corresponding to and matches the track groove so that the insertion plate body can slide into the track groove along the front-to-rear direction of the organizer body and the top part of the insertion plate body is fixed firmly to the bottom part of the organizer body. Thus, users can adjust the insertion location of the insertion plate body according to the width of the gap between two seats in a car to match the width of the outer sides of the insertion plate bodies to the width of the aforementioned gap. Therefore, when the fixed insertion plate bodies are inserted into the gap between two seats, the insertion plate bodies closely lean against the sides of two seats and firmly position the organizer body to the location close to the side of the user for storing sundry items.

Another objective of the present invention is to include two recessed first deformation grooves in parallel on the inner side of the insertion plate body close to the track portion to form a bending part on the insertion plate body located near the top end and between the first deformation grooves, resulting in the width of two outer sides of the insertion plate bodies slightly larger than the width of the gap between two seats. Owing to the existence of the first deformation grooves, the bending part can be bent and deformed toward the direction of the adjacent insertion plate body so that the width of the outer sides of the insertion plate bodies matches the width of the gap between two seats.

### BRIEF DESCRIPTION OF THE DRAWINGS

For Patent Officers to better understand the novel features, operating principle and effects of the present invention, detailed descriptions accompanied by the drawings that show various embodiments of the present invention are provided as follows.

FIG. 1 is a schematic diagram of the in-car storage organizer of the prior art;

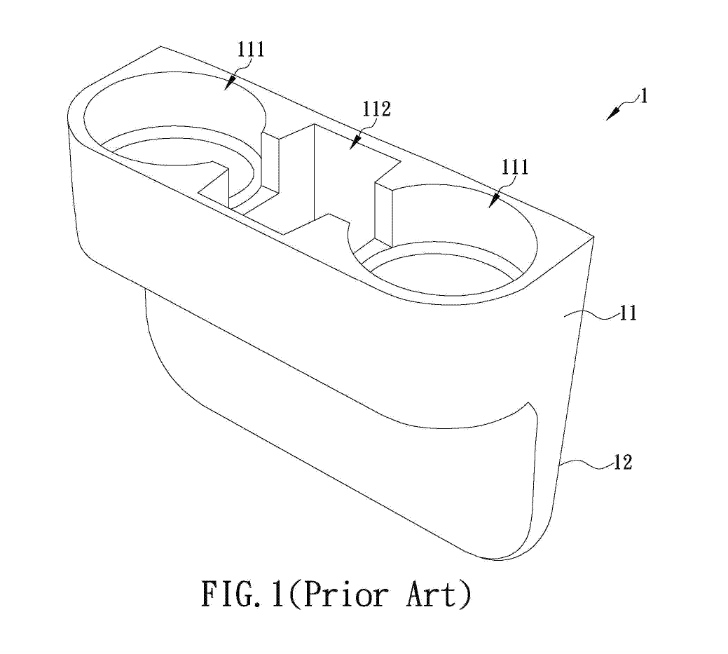

FIG. 2 is an exploded view of the in-car storage organizer of the present invention;

FIG. 3 is a schematic diagram of the external view of the in-car storage organizer of the present invention;

FIG. 4 is a schematic diagram of one assembly method of the in-car storage organizer of the present invention; and

FIG. 5 is a schematic diagram of another assembly method of the in-car storage organizer of the present invention.

### DETAILED DESCRIPTION OF THE PREFERRED EMBODIMENTS

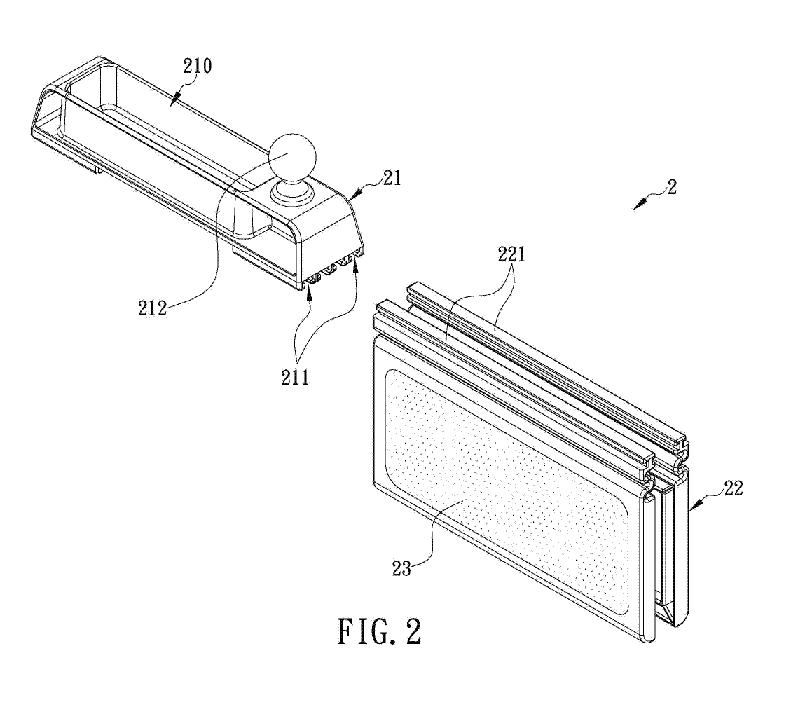

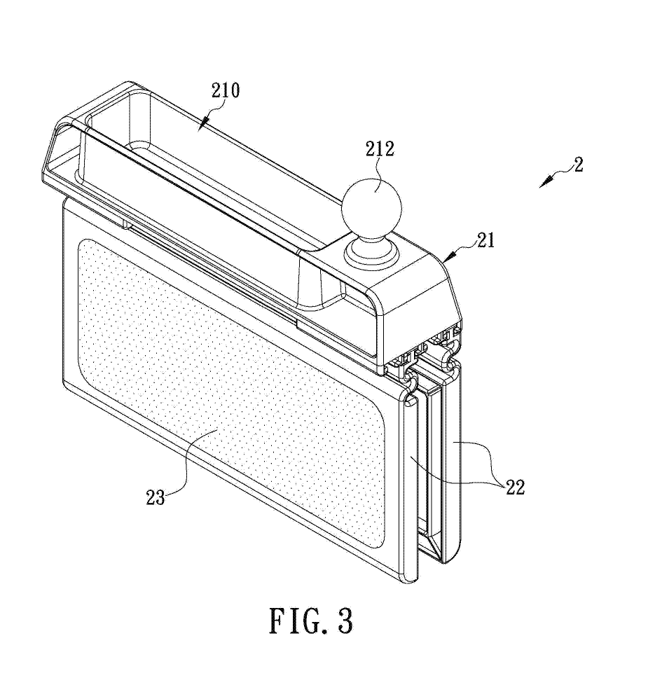

The present invention relates to an in-car storage organizer having insertion plate bodies of adjustable position to match the gap between seats. Please refer to FIG. 2 and FIG. 3 for the illustration of the preferred first embodiment of the present invention. The in-car storage organizer 2 comprises an organizer body 21 and two insertion plate bodies 22. The structure of the organizer body 21 has the shape of a narrow seat body that can be manufactured by, but not limited to, plastic injection molding. The top part of the organizer body 21 is shaped into a storage part 210. In this embodiment, the storage part 210 is a storage slot. However, in the actual designs, the storage part 210 can be a storage platform (for example, for placing a tablet computer) or a cup holder (for example, for holding a water cup) and this shall be explained in advance.

The bottom part of the organizer body 21 is installed with at least three track grooves 211 along the front-to-rear direction of the in-car storage organizer 2 (in this embodiment, there are four track grooves). These track grooves 211 are in parallel to one another. The top end of each insertion plate body 22 has a track portion 221 wherein the structure of the track portion 221 is corresponding to and matches the track groove 211 so that the insertion plate body 22 can slide into the track groove 211 along the front-to-rear direction of the organizer body 21 and the top part of each insertion plate body 22 is fixed firmly to the bottom part of the organizer body 21. Please refer to FIG. 2 to FIG. 4. The cross section view of the structure of the track groove 211 appears to be the shape of “T” letter. Therefore, these insertion plate bodies 22 can only be inserted to the track grooves 211 from the front or the rear of the organizer body 21 and, once inserted, the insertion plate bodies 22 will not fall off from below the organizer body 21.

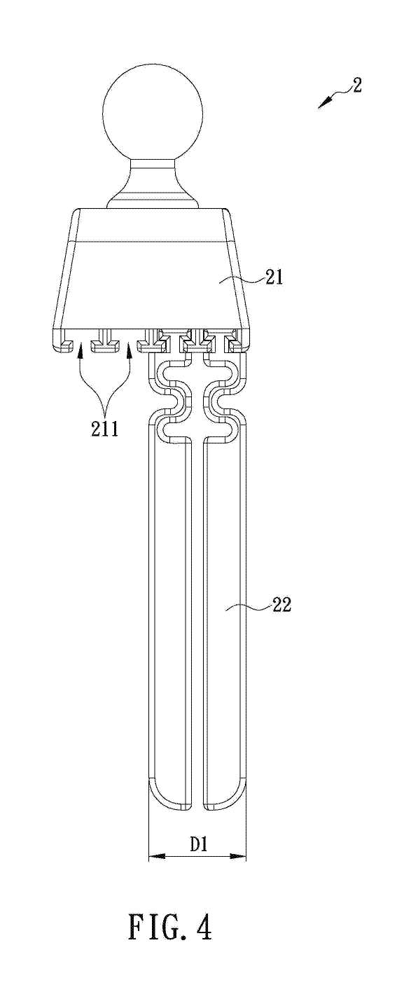

Thus, the user only needs to insert the insertion plate bodies 22 into the gap between two seats of the car and place the organizer body 21 at a location at the side of the seat within arm's reach distance of the user. The user can place the frequent use personal items (such as mobile phone, soft drink cup, and charging cable) in the storage part 210 to be used at any time. Please refer to FIG. 2 to FIG. 5. When the gap between two seats is smaller, the user can adjust and insert the insertion plate bodies 22 to adjacent track grooves 211 (as illustrated in FIG. 4). Due to the narrower width D1 between the outer sides of the insertion plate bodies 22, the insertion plate bodies 22 can be inserted into the gap and seamlessly adjacent to the sides of the seats.

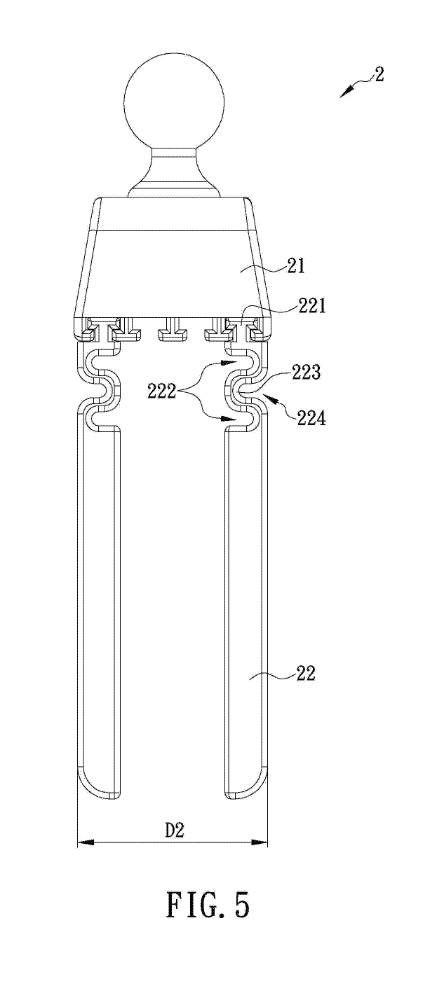

On the contrary, when the gap between two seats is larger, the user can adjust and insert the insertion plate bodies 22 to the track grooves 211 that are not adjacent to each other (as illustrated in FIG. 5). Due to the wider width D2 between the outer sides of the insertion plate bodies 22, the insertion plate bodies 22 can be seamlessly inserted into the gap and closely lean against the sides of two seats. In addition, since only the top part of each insertion plate body 22 is fixed firmly to the bottom part of the organizer body 21, even if the width between the outer sides of the insertion plate bodies 22 is slightly larger than the width of the gap between the seats, due to its own elasticity, every insertion plate body 22 can slightly curve inward so that the insertion plate bodies 22 still can seamlessly press against the sides of two seats separately to ensure the stable positioning of the organizer body 21.

Please refer to FIG. 2 to FIG. 5 again. In this embodiment, each insertion plate body 22 has two recessed first deformation grooves 222 in parallel on the inner side thereof close to the track portion 221 to form a bending part 223 on the insertion plate body 22 located near the top end and between the first deformation grooves 222, resulting in the width of two outer sides of the insertion plate bodies 22 slightly larger than the width of the gap between two seats. Owing to the existence of the first deformation grooves 222, the bending part 223 can be bent and deformed toward the direction of the adjacent insertion plate body 22 so that the width of the outer sides of the insertion plate bodies 22 matches the width of the gap between two seats.

Consequently, in this embodiment, the outer side of each insertion plate body 22 corresponding to the location of the bending part 223 also has a second deformation groove 224 installed thereon. The first deformation grooves 222 and the second deformation groove 224 make the thickness of the bending part 223 smaller than the thickness of the middle section portion of the insertion plate body 22. When the insertion plate bodies 22 are inserted into the gap between seats, the bending part 223 can be deformed more easily and the elasticity of the insertion plate body 22 can exert most.

Furthermore, an anti-slip pad 23 is disposed on the surface of the outer side of every insertion plate body 22 separately. The anti-slip pad 23 can be fixed on the insertion plate body 22 by pasting or can be inserted in one groove on the insertion plate body 22. The surface friction of the material used for the anti-slip pad 23 shall be larger than the surface friction of the outer side of the insertion plate body 22, making the insertion plate bodies 22 to be more firmly fixed inside the gap. A shaft bearing 212 is located on the organizer body 21 close to the storage slot (that is, storage part 210) and is used for installing a tablet computer support rack or a detachable portable table top.

The in-car storage organizer 2 of the present invention not only can adjust the width between the insertion plate bodies 22, but also has extreme flexibility in use. Please refer to FIG. 3 again. If the storage organizer 2 had the structure of the prior art, having a fixed insertion plate body 22 that is not adjustable, the in-car storage organizer 2 then can only be inserted to the gap between seats at the “left side” location with respect to the user (considering the right lower corner as the front and the left upper corner as the rear). When the user tries to insert the in-car storage organizer 2 between seats at the “right side” location with respect to the user, the user has to turn the front and rear of the in-car storage organizer 2 around, making the shaft bearing 212 originally located at the front to be at the rear end of the in-car storage organizer 2 (near the position where the user's elbow is) in order to insert the in-car storage organizer 2 into the gap between seats. However, by doing so, the shaft bearing 212 will be located at the position where the user's elbow is. Although the organizer can be used to hold and store smart devices, users are unable to operate naturally and normally.

Please refer to FIG. 3 to FIG. 5 again. Since the insertion plate body 22 of the present invention can be inserted into different track grooves 211 selectively by the user, therefore, if the user wants to insert the in-car storage organizer 2 to the gap to the right side of the seat and keeps the shaft bearing 212 still at the front end of the in-car storage organizer 2, the user only needs to adjust and insert the insertion plate bodies 22 to the two track grooves 211 at the far most right side. Therefore, the in-car storage organizer 2 can be directly inserted to the gap between seats to the user's right side and the shaft bearing 212 still remains at the front end of the in-car storage organizer 2 for use conveniently.

While the invention herein disclosed has been described by means of specific embodiments, numerous modifications and variations could be made thereto by those skilled in the art without departing from the scope of the invention set forth in the claims.

What is claimed is:

1. An in-car storage organizer having insertion plate bodies of adjustable position to match the gap between seats, which comprises:
an organizer body, wherein the top part thereof is shaped into a storage part; the bottom part thereof is installed with at least three track grooves along the direction of front-to-rear;
these track grooves are in parallel to one another; and
two insertion plate bodies, wherein the top end of each insertion plate body has a track portion; the structure of the track portion is corresponding to and matches the track groove so that the insertion plate body can slide into the track groove along the front-to-rear direction of the organizer body and the top part of the insertion plate body is fixed firmly to the bottom part of the organizer body;

2. The in-car storage organizer as claimed in claim 1, wherein the inner side of the insertion plate body close to the track portion is disposed with two recessed first deformation grooves in parallel thereon to form a bending part on the insertion plate body located near the top end and between the first deformation grooves; when the width of two outer sides of the insertion plate bodies slightly larger than the width of the gap between two car seats, owing to the existence of the first deformation grooves, the bending part can be bent and deformed toward the direction of the adjacent insertion plate body so that the width of the outer sides of the insertion plate bodies matches the width of the gap between two seats.

3. The in-car storage organizer as claimed in claim 2, wherein the outer side of each insertion plate body corresponding to the location of the bending part also has a second deformation groove installed thereon so that the thickness of the bending part is smaller than the thickness of the middle section portion of the insertion plate body.

4. The in-car storage organizer as claimed in claim 1, wherein an anti-slip pad is disposed on the surface of the outer side of every insertion plate body separately; the anti-slip pad's surface friction is larger than the surface friction of the outer side of the insertion plate body.

5. The in-car storage organizer as claimed in claim 2, wherein an anti-slip pad is disposed on the surface of the outer side of every insertion plate body separately; the anti-slip pad's surface friction is larger than the surface friction of the outer side of the insertion plate body.

6. The in-car storage organizer as claimed in claim 3, wherein an anti-slip pad is disposed on the surface of the outer side of every insertion plate body separately; the anti-slip pad's surface friction is larger than the surface friction of the outer side of the insertion plate body.

7. The in-car storage organizer as claimed in claim 4, wherein a shaft bearing is disposed on the organizer body at the location close to the storage part.

8. The in-car storage organizer as claimed in claim 5, wherein a shaft bearing is disposed on the organizer body at the location close to the storage part.

9. The in-car storage organizer as claimed in claim 6, wherein a shaft bearing is disposed on the organizer body at the location close to the storage part.

10. The in-car storage organizer as claimed in claim 7, wherein the storage part is a storage slot.

11. The in-car storage organizer as claimed in claim 8, wherein the storage part is a storage slot.

12. The in-car storage organizer as claimed in claim 9, wherein the storage part is a storage slot.
